(19) United States
(12) Patent Application Publication
(10) Pub. No.: US 2017/0367300 A1
(43) Pub. Date: Dec. 28, 2017

(54) HANDS FREE PET WALKING DEVICE

(71) Applicant: Maria Hampton, Flagstaff, AZ (US)

(72) Inventor: Maria Hampton, Flagstaff, AZ (US)

(21) Appl. No.: 15/194,941

(22) Filed: Jun. 28, 2016

(51) Int. Cl. A01K 27/00; A41F 9/00

(52) U.S. Cl. CPC A01K 27/00; A41F 9/007; A01K 27/003; A41F 9/002

(57) ABSTRACT

A hands free device for walking a pet is provided. In one implementation, the hands free device comprises a restraining device for restraining a pet and a belt attached to the restraining device. The belt comprises a belt-loop assembly having a first portion and a second portion and a fastener device attached to the belt-loop assembly and the belt. In this regard, the belt-loop assembly is to receive a handle portion of the restraining device. The first portion of the belt-loop assembly is attached to the belt. The second portion of the belt-loop assembly is for engaging and disengaging from the belt. The fastener device is adapted to releasably attach the second portion of the belt loop assembly to the surface of the belt.

### TECHNICAL FIELD

Embodiments of the present disclosure relate generally to a device for use with a pet and more specifically, but without limitation, to a hands free pet walking device.

### BACKGROUND

Many people walk their pets every day. During these walks, leashes allow individuals to restraint their pets. In addition, many municipalities may require that certain pets (e.g., dogs) be on leaches when the are walked in public. Generally a hand held chain, strap, cord, etc., is used for controlling or leading a dog or other animal while walking or running.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 is an illustration of an example of a hands free pet waking device in accordance with embodiments of the present disclosure.

FIG. 2A is a perspective view of a hands free device in accordance with one embodiment of the present disclosure.

FIG. 2B is another view of the hands free device of FIG. 2A in accordance with one embodiment of the present disclosure.

FIG. 2C is another view of the hands free device of FIG. 2A in accordance with one embodiment of the present disclosure.

FIG. 2D is another view of the hands free device of FIG. 2A in accordance with one embodiment of the present disclosure.

FIG. 3 is an illustration of another example of a hands free pet waking device in accordance with embodiments of the present disclosure.

### DETAILED DESCRIPTION

Embodiments of the present disclosure provide a hands free pet walking device, which enables a person to walk their pet without having to hold a leash. Generally, when walking, jogging or running with a pet, a person's movements are limited by holding the leash within their hand. In some situations, a person may have suffered a type of arm or hand injury that limits their ability to control the pet without fear of being re-injured. For example, the person may have experienced a rotator cuff injury that makes it difficult to walk a pet or multiple pets using hand leaches. In such cases, the person may have difficulty in controlling the pet, if the pet suddenly jerks, jumps or pulls on the leash.

In accordance with the disclosure, the hands free pet walking device is provided for use with one or more pets or animals. In some implementations, the hands free pet walking device includes a restraining device (e.g., leash) for restraining a pet and a belt releasably coupled to the leash. For example, the belt may include a belt-loop assembly that can receive and hold onto a handle portion of the restraining device. The belt is sized to fit around the waist of a person while the leash is attached to a collar of the pet. The device enables the person to freely move with their pet without using their hands. This allows the person to maintain control of the one or more pets, such as during walking activities, while minimizing any impact on that person.

The present disclosure relates to a device for performing the operations herein. In the following description, numerous details are set forth. It will be apparent, however, to one skilled in the art, that the present disclosure may be practiced without these specific details. In some instances, well-known structures and devices are shown in block diagram form, rather than in detail, in order to avoid obscuring the present disclosure.

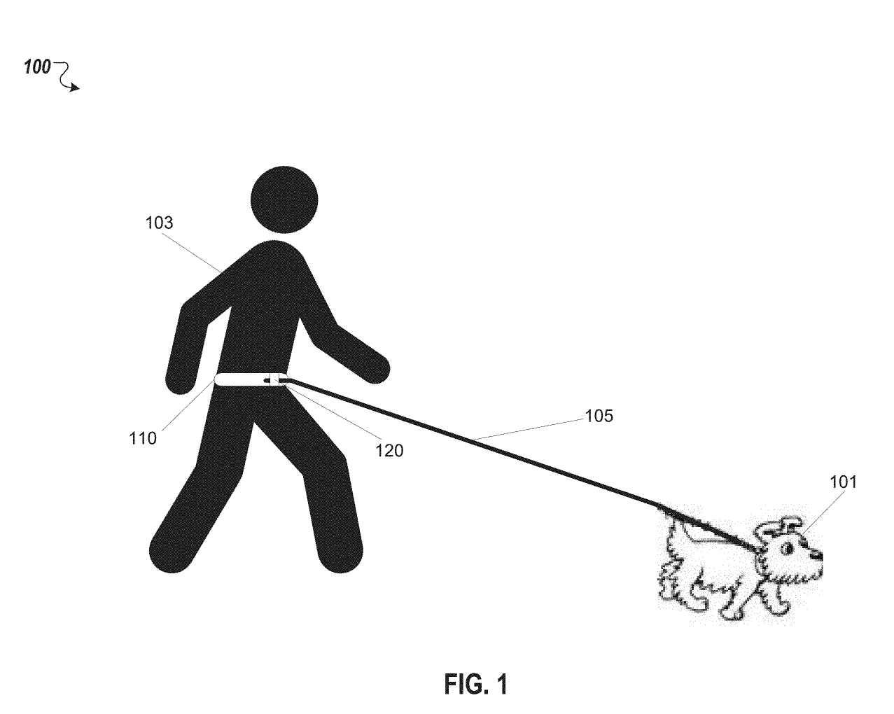

FIG. 1 is an illustration of an example of a hands free pet waking device 100 in accordance with embodiments of the present disclosure. The hands free pet waking device 100 provides for secure retention of one or more pets, such as pet 101, to a user 103. In some implementations, the device 100 includes a restraining device 105 (e.g., a leash) and a belt 110 attached to the restraining device 105. The device 100 is for use with the pet 101, such as a dog or cat, in a manner that allows the user 103 to control or otherwise restrain the pet 101 without having to use their hands.

As shown in FIG. 1, one end of the restraining device 105 is coupled to the pet 101. For example, restraining device 105 may be coupled to a collar wrapped around the pet 101. In some implementations, the restraining device 105 may include a type of latch (not shown) that can engage and disengage from the collar of the pet 101. The other end of the restraining device 105 may be coupled to the belt 110. For example, a handle end of the restraining device 105 may be coupled to a belt-loop assembly 120 of the belt 110. Although, only one belt-loop assembly 120 is shown in device 100 for simplicity, the device 100 may include a plurality of belt-loop assemblies. For example, additional belt-loop assemblies, such as belt-loop assembly 120, may be attached to the belt 100. Each belt-loop assembly 120 may be adapted to hold an additional restraining device, such as restraining device 105, in order to accommodate additional pets to control with the device 100 during certain outdoor/indoor activities (e.g., walking, jogging, etc.).

To secure the restraining device 105 to the belt-loop assembly 120, the device 100 may include a type of fastener (not shown). The fastener is adapted to releasably couple the belt loop assembly 120 to a surface of the belt 110. For example, the fastener may be attached to the belt loop assembly 120 and the surface of the belt 110 and is configured to be opened and closed. If the fastener is in an open position, the handle end of the restraining device 105 may pass through the belt-loop assembly 120. If the fastener is in a closed position, the handle portion of the restraining device 105 is held securely within the belt-loop assembly 120 of the belt 110 so that the person may freely move with their pet without using their hands to control the pet.

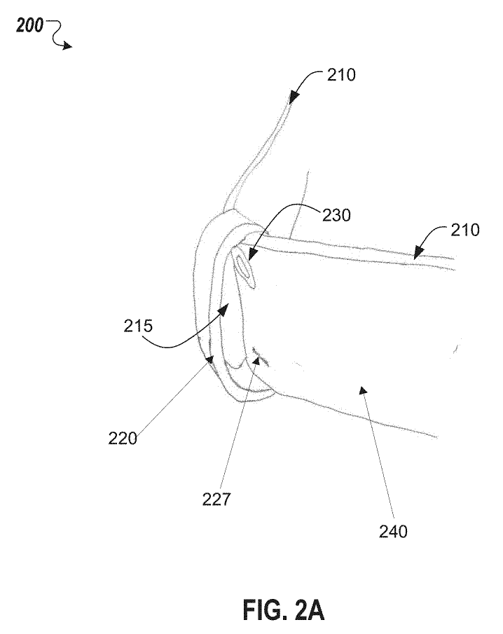

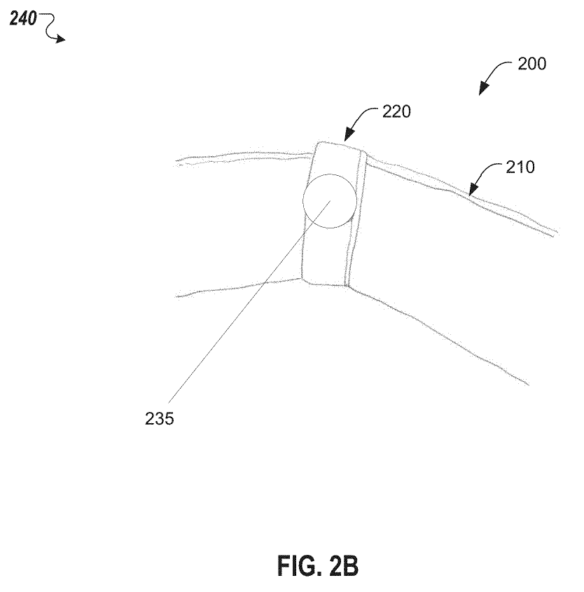

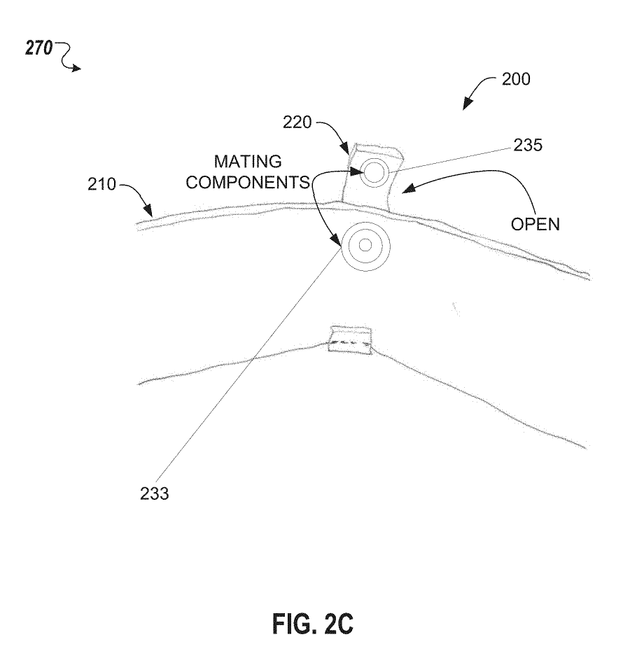

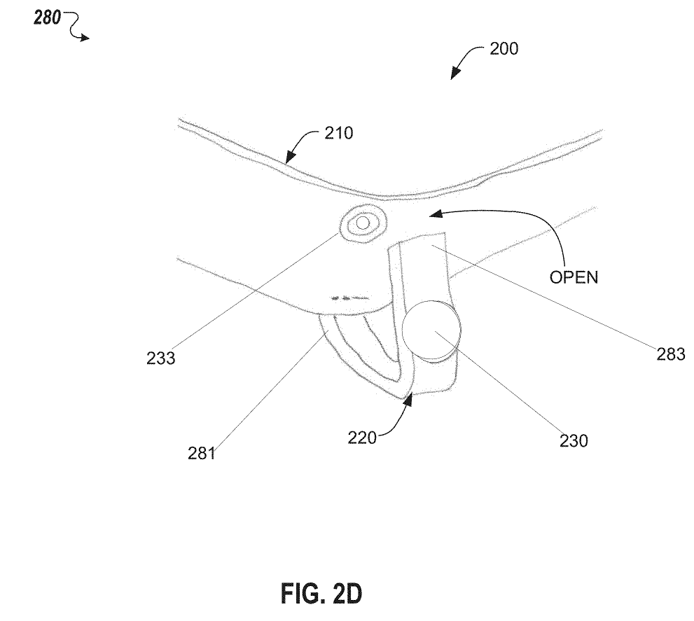

FIGS. 2A-2D are perspective views of a hands free device 200 in accordance with one embodiment of the present disclosure. The hands free device 200 may be compared to the hands free pet waking device 100 of FIG. 1. For example, the hands free device 200 comprises a belt 210 (which may be compared to belt 110 of FIG. 1) and a belt-loop assembly 220 (which may be compared to belt-loop assembly 120 of FIG. 1) attached to the belt 210. In some implementations, the belt-loop assembly 220 is adapted to hold a restraining device (not shown), such as a leash, which is attached to a pet.

Turning to FIG. 2A, the belt 210 can be sized to fit around the waist of a user. For example, the belt 210 may include catch or other type of clasp (not shown) that can be adjusted as necessary for various sized users to wear the belt comfortably. In alternative implementations, the belt 210 may be constructed in various sizes for particular shaped users. In some implementations, the belt 210 is comprised of a number of different types of materials that provide flexibility as well as a level of tensile strength. In one implementation, the belt 210 may be comprised of leather of a certain thickness or other types of materials of similar properties.

The belt-loop assembly 220 may be comprised of a number of different types of materials that may be similar or different from the material used to construct the belt 210. For example, the belt-loop assembly 220 may be comprised of a material that provides flexibility as well as a level of tensile strength, such as leather. In some implementations, the belt-loop assembly 220 can be constructed at the same time as the belt 210. In an alternative implementation, the belt-loop assembly 220 can be constructed at a different time and later attached to the belt 210.

In some implementations, the belt-loop assembly 220 can be of a certain size to accommodate a restraining device, such as a leash, for restraining a pet (e.g., a dog). For example, the belt-loop assembly 220 may be sized so that a handle portion of the restraining device can be held within a cavity 215 created between the belt-loop assembly 220 and the belt 210. In alternative implementations, one or more restraining devices can be held by the belt-loop assembly 220 within the cavity 215. Preferably, there is one restraining device for each the belt-loop assembly 220 attached to the belt 210.

To attach the belt-loop assembly 220 to the belt 220, various manufacturing methods can be used. For example, the belt-loop assembly 220 can be attached to the belt 220 using a type of stitching or threading. In the regard, a connector 227 (e.g., threading) may be used to attach the belt 220 and the belt-loop assembly 220. In one implementation, the belt 220 is threaded through with the connector 227 and then secured to the belt-loop assembly 220. In alternative implementations, the belt 220 can be manufactured so that one end of the belt-loop assembly 220 is permanently attached or part of the belt 210.

In some implementations, the hands free device 200 also includes a fastener assembly 230. The fastener is adapted to releasably couple the belt loop assembly 210 to the belt 210. In that regard, a first portion of the fastener assembly 230 may be attached to a surface 240 of the belt 210. On an opposite side of the belt 210, a second portion of the fastener assembly 230 is disposed.

Turning to FIG. 2B, another view 240 of the hands free device 200. Here, a second portion 235 of the fastener assembly 230 is shown disposed thereon. In one implementation, the first portion of the fastener assembly 230 is arranged for mating connection to the second portion 235. When the first portion and the second portion 235 of the fastener assembly 230 are engaged, such as by pressing the two together, the hands free device 200 is situated in a closed position. In the closed position, the opening 215 in the belt loop assembly 210 is closed so that the handled of the restraining device is secured therein. Conversely, if the first portion and the second portion 235 of the fastener assembly 230 are separated or pulled apart, the hands free device 200 is then situated in an open position. In the open position, the opening 215 in the belt loop assembly 210 is open so that the handle of the restraining device can be removed or placed therein.

With regards to FIG. 2C, another view 270 of the hands free device 200 of FIG. 2A is shown. In this example, the hands free device 200 is illustrated in an open position. For example, the mating components of the fastener assembly 230 (e.g., the first and second the portions 233, 235) are shown separated or disengaged. In this regard, the mating components of the fastener assembly 230 may include different type of buttons, clasps, fasteners, etc., that can be repeatedly separated and mated together. As noted above, when the hands free device 200 is situated in an open position, this open position allows a restraining device (for restraining a pet) to pass through of the fastener assembly 230 so as to be placed therein.

Turning to FIG. 2D, another view 280 of the hands free device 200 of FIG. 2A is shown. As shown, the hands free device 200 is situated in an open position. For example, the first and second the portions 233, 235 of the fastener assembly 230 are separated from each other. In this position, a first portion 281 of the belt-loop assembly 220 may remain attached to the belt 210 while a second portion 283 is disengaged from a surface of the belt 210.

As noted above, the belt-loop assembly 220 is adapted to receive a handle portion of the leash. For example, when the second portion 283 of the belt-loop assembly 220 is disengaged from a surface of the belt 210, a handle portion of the restraining device can pass through the second portion 283. This is so that the handle of the restraining device may rest within the belt-loop assembly 220. The second portion 283 of the belt-loop assembly 220 may then be re-engaged with the surface of the belt 210 by pressing the two together, thereby allowing a fastener, such as fastener 230, of the hands free device 200 to be snapped in place.

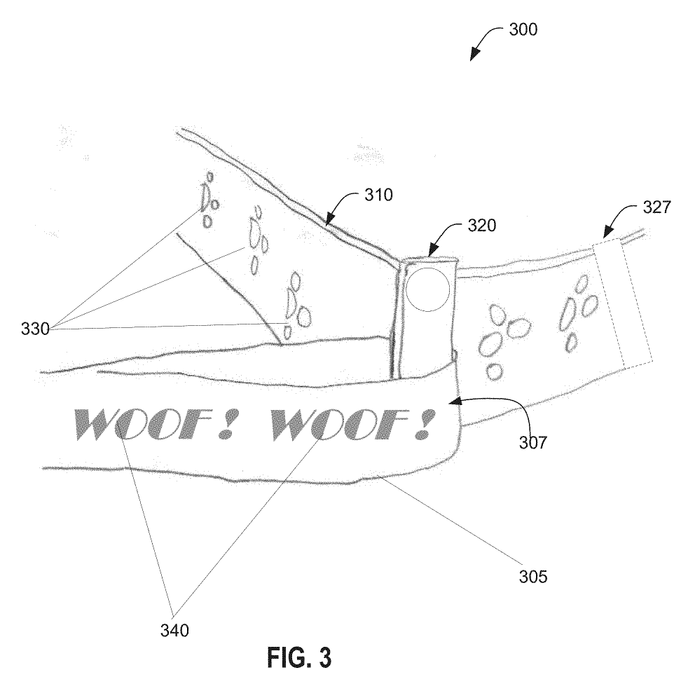

FIG. 3 is an illustration of another example of hands free pet waking device 300 in accordance with embodiments of the present disclosure. The hands free pet waking device 300 may be compared to the hands free pet waking device 100 of FIG. 1 and the hands free device 200 of FIG. 1. For example, the hands free pet waking device 300 comprises a belt 310 (which may be compared to belt 110 of FIG. 1 and belt 210 of FIG. 2) and a belt-loop assembly 320 (which may be compared to belt-loop assembly 120 of FIGS. 1 and 220 of FIG. 2) attached to the belt 310. In this example, the device 300 includes a restraining device 305 (which may be compared to restraining device 105 of FIG. 1), such as a leash, for restraining a pet attached thereto.

As shown, the belt-loop assembly 320 may be coupled to the restraining device 305. For example, the belt-loop assembly 320 may be adapted to hold a handle portion 307 of the restraining device 305. In some implementations, the device 300 may include additional belt-loop assemblies, such as belt-loop assembly 327. Each belt-loop assembly may be configured to retain a restraining device, such as restraining device 305, which is attached to an individual pet. In one implementation, the additional belt-loop assemblies, such as belt-loop assembly 320 and 327, may be spaced along the belt 310 so that a user can attached up to four (4) pets to the belt 310. In that regard, each belt-loop assembly may be attached to a pet that is situated on either side (e.g., left and right) of the user and the front and back of the user.

In some implementations, the belt 300 may comprise a printed pattern 330 or a message, such as message 340. Similarly, the restraining device 305 may comprise a message 340 or a printed pattern, such as printed pattern 330. The printed pattern 330 and/or message may be disposed in such a manner that allows it to be displayed as the user moves with their pet. For example, the message 340 may display inspirational words, such as “Believe”, “Just Believe” or Hope.” In other implementations, the belt 310 and/or the restraining device 305 can be manufactured in different colors and patterns to accommodate the preferences of different users.

Reference throughout this specification to “one embodiment” or “an embodiment” means that a particular feature, structure, or characteristic described in connection with the embodiment is included in at least one embodiment of the disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. A hands free device for walking a pet comprising:
a restraining device for restraining a pet; and
a belt attached to the restraining device, wherein the belt comprises:
a belt-loop assembly having a first portion and a second portion, wherein the first portion is attached to the belt and the second portion for engaging and disengaging from the belt, wherein the belt-loop assembly is to receive a handle portion of the restraining device; and
a fastener device attached to the belt-loop assembly and the belt, wherein the fastener device is to releasably attach the second portion of the belt loop assembly to the surface of the belt.

2. The hands free device of claim 1, wherein the belt is sized for a waist of a person.

3. The hands free device of claim 1, wherein the belt is constructed from a material comprising leather.

4. The hands free device of claim 1, wherein a surface of the belt comprises a printed pattern.

5. The hands free device of claim 1, wherein a surface of the belt comprises a message.

6. The hands free device of claim 1, wherein the belt-loop assembly is comprised of a flexible material.

7. The hands free device of claim 1, wherein the fastener device comprises a first portion attached to the belt loop assembly and a second portion attached to the belt.

8. The hands free device of claim 7, wherein the first portion is arranged for mating connection to the second portion.

9. The hands free device of claim 1, wherein the second portion of the belt-loop assembly is adapted to pass through the handle portion of the restraining device.

10. The hands free device of claim 1, wherein the restraining device comprises a printed pattern.

11. The hands free device of claim 1, wherein the restraining device comprises a message.

12. A hands free device for walking a pet comprising:
a belt;
a belt loop assembly having a first portion and a second portion, wherein the first portion is attached to the belt and the second portion for engaging and disengaging from the belt, wherein the belt loop assembly is adapted to receive a portion of a leash for use with the pet; and
a fastener assembly attached to the belt loop assembly and the belt, wherein the fastener assembly to releasably attach the second portion of the belt loop assembly to the surface of the belt.

13. The hands free device of claim 12, wherein a size of the belt is adjustable.

14. The hands free device of claim 12, wherein the belt is constructed from a material comprising leather.

15. The hands free device of claim 12, wherein a surface of the belt comprises a message.

16. The hands free device of claim 12, wherein a surface of the belt comprises a printed pattern.

17. The hands free device of claim 12, wherein the fastener assembly comprises a first portion attached to the belt loop assembly and a second portion attached to the belt.

18. The hands free device of claim 17, wherein the first portion is arranged for mating connection to the second portion.

19. The hands free device of claim 12, wherein the second portion of the belt-loop assembly is adapted to pass through the handle portion of the leash.

20. The hands free device of claim 12, wherein the leash comprises a message.
